(19) United States
(12) Patent Application Publication
(10) Pub. No.: US 2024/0318021 A1
(43) Pub. Date: Sep. 26, 2024

(54) INKS FOR IMPROVING PRINTHEAD LIFETIME

(71) Applicant: MEMJET TECHNOLOGY LIMITED, Leopardstown (IE)

(72) Inventors: Ellaine Munton, North Ryde (AU); Iain Blake, North Ryde (AU)

(21) Appl. No.: 18/581,620

(22) Filed: Feb. 20, 2024

Related U.S. Application Data
(60) Provisional application No. 63/491,814, filed on Mar. 23, 2023.

(51) Int. Cl. C09D 11/328; B41J 2/14; C09D 11/033; C09D 11/106

(52) U.S. Cl. CPC C09D 11/328; B41J 2/14112; C09D 11/033; C09D 11/106

(57) ABSTRACT

An inkjet ink includes an aqueous-based ink vehicle and 5 to 250 ppm of a polyvinyl alcohol. The ink is useful for improving the lifetime of inkjet printheads, especially printheads with inkjet nozzle devices having resistive heater elements susceptible to failure by corrosion.

### PRIORITY

This application claims the benefit of priority to U.S. Provisional Patent Application Ser. No. 63/491,814 filed Mar. 23, 2023, of the same title, the contents of which being incorporated herein by reference in its entirety.

### FIELD OF THE DISCLOSURE

This present disclosure relates to an inkjet ink. It has been developed primarily for improving the lifetime of printheads, and particularly thermal inkjet printheads.

### BACKGROUND OF THE DISCLOSURE

The present Applicant has developed a plethora of high-speed inkjet printers employing stationary Memjet® printheads which extend across a media width.

High-speed pagewidth printing necessarily places additional demands on the design of the printhead compared to traditional types of inkjet printhead. The nozzle devices must have a self-cooling design, high ink refill rates and high thermal efficiency. To this end, the Applicant has developed a range of thermal bubble-forming printheads, including those with suspended resistive heater elements (as described in, for example, U.S. Pat. Nos. 6,755,509; 7,246,886; 7,401,910; and 7,658,977, the contents of which are incorporated herein by reference) and those with embedded (“bonded”) resistive heater elements (as described in, for example, U.S. Pat. Nos. 7,377,623; 7,431,431; US 2006/250453; and U.S. Pat. No. 7,491,911, the contents of which are incorporated herein by reference).

Nozzle devices having uncoated, suspended heater elements offer the advantages of efficient heat transfer from the heater element to the ink and optimal self-cooling characteristics. However, they suffer from the disadvantage of relatively short printhead lifetimes, because uncoated, suspended heater elements are typically less robust than their bonded counterparts.

Ink components may shorten printhead lifetimes either by a corrosive or kogative failure mechanism. Dye-based inks tend to shorten lifetimes via a corrosive failure mechanism. On the other hand, inks containing polymers (e.g. pigment-based inks) tend to shorten lifetimes via a kogative failure mechanism. However, there is inevitably a balance between corrosive and kogative failure mechanisms in both dye-based and pigment-based inks depending on, for example, the type of heater element.

In a multi-color printhead (e.g. CMYK), the printhead lifetime is, in practice, limited by the lifetime of the color channel having the shortest lifetime. If, for example, a black dye-based ink is found to be particularly corrosive towards heater elements, then the lifetime of the printhead will be determined by the lifetime of the black channel, even if all other color channels still perform well when the black color channel fails.

In the present context, “failure” of a nozzle device means any change in drop ejection characteristics which results in unacceptable print quality. For example, failure may be invoked by a reduction in drop velocity, poor drop directionality (e.g. greater than 2 pixel misdirection) or non-ejection of ink. Moreover, the criteria for failure may be different for different colors. For example, a reduction in print quality in a yellow channel may be more tolerable than a corresponding reduction in print quality in a black channel, because black ink is more visible to the human eye (i.e. black ink has a higher luminance on white paper). This, in combination with the aggressive nature of many black dyes, means that the black channel in a Memjet® printhead is often the limiting color channel in terms of printhead lifetime.

One approach to improving printhead lifetime is to coat the heater elements with a layer of protective coating. For example, U.S. Pat. No. 6,719,406 (assigned to the present Applicant) describes suspended heater elements having a conformal protective coating, which improves the robustness of the heater element and improves printhead lifetime. However, protective coatings may be undesirable for a number of reasons-they reduce the efficiency of heat transfer from the resistive heater elements to the surrounding ink; they consequently affect the self-cooling characteristics; and they introduce additional MEMS fabrication challenges.

Another approach to improving printhead lifetimes is to introduce certain additives (e.g. anti-corrosion additives) into the ink formulation.

U.S. Pat. No. 6,435,659 (assigned to Hewlett-Packard Company) describes inks containing aluminium ions for suppressing heater corrosion. It is reported that the metal ions form a film layer on the resistive heater surface, thereby protecting heater elements from attack by corrosive components in the ink.

U.S. Pat. No. 9,422,441 (the contents of which are incorporated herein by reference) describes Butoxyne™ additives as a means for reducing corrosion in printheads having resistive heater elements. Whilst such additives are effective in increasing printhead lifetimes, Butoxyne™ suffers from challenging supply issues, which are undesirable for consistently manufacturing large quantities of ink for commercial use.

It would be desirable to improve the lifetime of thermal inkjet printheads using alternative ink formulation additives. It would be further desirable for such additives to be widely available and at least as effective as known additives for reducing corrosion and improving printhead lifetimes. It would be further desirable for such additives to be used in minimal quantities and with minimal impact on other required ink characteristics.

### SUMMARY OF THE DISCLOSURE

In one aspect, an inkjet ink is disclosed. In one embodiment, the inkjet ink includes:
an aqueous-based ink vehicle; and
5 to 250 ppm of a polyvinyl alcohol.

Inks according to one aspect exhibit a significant improvement in printhead lifetimes compared with similar inks lacking the polyvinyl alcohol (PVA) additive or, indeed, other polymer additives. Typically, a printhead lifetime improvement of at least 25%, at least 50%, at least 100% or at least 200% may be achievable by employing inks according to the first aspect. Surprisingly, inks according to the first aspect exhibit an advantageous improvement in printhead lifetime at very low concentrations of the PVA additive. At these low concentrations, printhead failure via a competing kogative mechanism is minimized. Furthermore, an established balance of desirable ink characteristics is not significantly altered by adding a very small quantity of PVA to the ink.

Preferably, the polyvinyl alcohol (PVA) is present in an amount ranging from 10 to 200 ppm, or preferably 10 to 100 ppm.

Preferably, the polyvinyl alcohol has a molecular weight in the range of 5000 to 15,000 g/mol, or preferably 7000 to 11,000 g/mol. Relatively low molecular weight PVAs are generally preferred from the point of view of solubility, enabling convenient formulation of the ink as well as optimal lifetimes.

Preferably, the polyvinyl alcohol has a degree of hydrolysis in the range of 70 to 90%, or preferably 75 to 85%. PVAs having a relatively low degree of hydrolysis are generally preferred from the point of view of solubility, enabling convenient formulation of the ink.

Typically, the ink contains a corrosive component, which may be, for example, a water-soluble anion or an organic compound having an anionic group. Examples of corrosive components include chloride, bromide, iodide, sulfate and nitrate ions, as well as organic compounds containing one or more sulfonate groups.

Typically, the corrosive component comprises a dye. The dye may be present in an amount ranging from 0.01 to 5 wt. % or 0.02 to 2 wt. %.

In one preferred embodiment, the ink is absent any polymers having a molecular weight greater than 5000 g/mol, other than the polyvinyl alcohol. Inks according to this preferred embodiment advantageously exhibit minimal kogation of heater elements, thereby maximizing the printhead lifetime. In another preferred embodiment, the ink is absent any polymers having a molecular weight greater than 3000 g/mol, other than the polyvinyl alcohol.

Notably, polymers having a molecular weight greater than 5000 g/mol do not include, for example, alkoxylated (e.g. ethoxylated) surfactants or alkoxylated (e.g. ethoxylated) glycerols commonly used in inkjet inks. Examples of typical ethoxylated surfactants used in inkjet inks include ethoxylated acetylenic diols, commercially available as Surfynols® (e.g. Surfynol 2502, Surfynol 420, Surfynol 440, Surfynol 465, Surfynol 485 etc. sold by Air Products), and ethoxylated silicones, commercially available as BYK-345, BYK-346 and BYK-349 (sold by BYK Japan K. K.) and Silface™ SAG-002, SAG-005, SAG-008, SAG-KB and SAG-503A (sold by Nissin Chemical Industry Co.). An example of a typical ethoxylated glycerol is the anti-kogation additive Liponic® EG-1 (26 molar equivalents of ethoxylate), commercially available from Lipo Chemicals.

Preferably, the ink vehicle comprises 5 to 50 wt. % of one or more co-solvents. The range of co-solvents is not particularly limited, and some suitable co-solvents for use in the present disclosure are described in more detail below. In some embodiments, the ink vehicle may comprise Liponic® EG-1 to assist in minimizing kogation.

Preferably, the ink vehicle comprises 0.05 to 2 wt % of at least one surfactant, as described below. The range of surfactants is not particularly limited and some suitable surfactants for use in the present disclosure are described in more detail below. For example, the surfactant may be an anionic, cationic, nonionic or zwitterionic surfactant.

In another aspect, methods of improving a lifetime of an inkjet printhead are disclosed. In one embodiment, the method includes the steps of:
supplying an ink as described above to nozzle chambers of the printhead, each nozzle chamber having an associated actuator in contact with the ink; and
actuating one or more of the actuators to eject ink from the printhead.

The method according to an aspect significantly improves printhead lifetimes compared to inks absent the PVA, as described herein.

Preferably, each actuator comprises a resistive heater element, which superheats ink so as to form a bubble and eject ink from the corresponding nozzle chamber via a nozzle opening.

In some embodiments, the heater element may be uncoated so that the ink is in direct contact with the resistive heater element. Such heater elements are particularly vulnerable to corrosive attack.

Preferably, the heater element is comprised of a metal or a conductive ceramic material, such as a metal nitride. As used herein, the term “metal” includes metal alloys containing a plurality of different metals. Preferably, the heater element is comprised of a material selected from the group consisting of: a titanium alloy (e.g. titanium-aluminium alloy); titanium nitride; and a nitride of a titanium alloy (e.g. titanium aluminium nitride).

In yet another aspect, an inkjet printer is disclosed. In one embodiment, the inkjet printer includes:
an inkjet printhead having a plurality of nozzle chambers, each nozzle chamber having an associated actuator for contacting ink; and
an ink reservoir in fluid communication with the nozzle chambers, the ink reservoir containing an ink as described above.

Preferred aspects of the printhead and ink will be readily apparent from the foregoing.

In yet another aspect, there is provided a use of an ink as described herein for improving a lifetime of an inkjet printhead.

As used herein, the term “ink” is taken to mean any printing fluid, which may be printed from an inkjet printhead. The ink may or may not contain a colorant. Accordingly, the term “ink” may include conventional dye-based or pigment-based inks, infrared inks, fixatives (e.g. pre-coats and finishers), 3D printing fluids (e.g. binder fluids), functional fluids (e.g. solar inks, sensing inks, etc.), biological fluids, and the like. Typically, the ink is a dye-based ink for use in thermal inkjet printheads. Where reference is made to fluids or printing fluids, this is not intended to limit the meaning of “ink” herein.

### BRIEF DESCRIPTION OF THE DRAWINGS

Various embodiments of the present disclosure will now be described by way of example only with reference to the accompanying drawings, in which:—

FIG. 1 is a perspective view of part of a thermal inkjet printhead;

FIG. 2 is a side view of one of the nozzle assemblies shown in FIG. 1;

FIG. 3 is a perspective of the nozzle assembly shown in FIG. 2; and

FIG. 4 is perspective view of a thermal inkjet print engine.

### DETAILED DESCRIPTION

The present inventors have sought a solution to the problem of improving printhead lifetime by investigating ink additives. As foreshadowed above, an ink additive is an attractive solution to this problem, because it does not require any modifications to the design of the printhead.

While Butoxyne™ (1,4-bis(2-hydroxyethoxy)-2-butyne) has previously been shown to improve printhead lifetimes in dye-based inks (see U.S. Pat. No. 9,422,441), the effectiveness of this additive exhibits some batch variability between different suppliers, as well as supply constraints. Initial efforts to find alternative additives with similar efficacy were generally unsuccessful. For example, it was hypothesized that zwitterionic compounds may be helpful in protecting heater elements, based on earlier work described in WO2022/184478. It was believed that zwitterions could help to repel anionic corrosive species via a double-layer effect at the heater surface. However, additives such as betaine were, in fact, found to be detrimental to heater life. Similarly, weak acids such as boric acid and ascorbic acid were either ineffective or detrimental to heater life.

In light of the batch variability of Butoxyne™ additives, it has been hypothesized that the active species in extending heater life was not a small alkyne molecule, but rather a water-soluble polymer transiently formed on the heater surface during drop ejection. The presence or otherwise of impurities in Butoxyne™ (which may either catalyse or hinder polymerization) or microscopic variations at individual heater surfaces may account for the observed variability in efficacy. Nevertheless, polymers are known to be highly kogative components in ink and were not expected to be effective in extending printhead lifetimes.

Initial experiments with a water-soluble ethoxylated silicone polymer proved the kogative hypothesis to be correct. With the addition of Dow Corning Dowsil™ 8526 at various concentrations to dye-based inks, rapid build up of kogation was observed as evidenced by poor drop ejection characteristics (e.g. low ejection velocities, misdirected droplets). However, despite the unsuitability of such kogative polymers, analysis of heater resistance rise during those experiments were encouraging. Heater resistance rise is a strong indicator of corrosion and the data showed a clear protective effect from the ethoxylated silicones (albeit at the expense of kogation) compared to similar formulations lacking the ethoxylated silicones.

With these encouraging data, attempts were made to reduce kogation by lowering the amount of silicone additive. While the anti-corrosive effects were observed at very low additive concentrations (about 10 ppm), the silicones still had unacceptable kogation even at low concentration. Addition of a known anti-kogation additive (Liponic® EG-1, an ethoxylated glyercol) was not particularly effective in improving the performance of the ethoxylated silicones with respect to kogation.

Although ethoxylated silicones were not effective in improving printhead lifetimes due to kogation, their effectiveness in limiting corrosion at very low concentrations (presumably via a protective layer at the heater surface) had been demonstrated. The present inventors therefore turned their attention to other water-soluble polymers that might have a similar anti-corrosive effect at low concentration, but without the deleterious kogative effects exhibited by silicones.

Surprisingly, it was found that polyvinyl alcohols were very effective in minimizing corrosion of heater elements at low concentrations, but without the same kogative impact as the silicones, thereby improving heater lifetimes overall. Remarkably, at concentrations of about 5 to 250 ppm, PVA exhibited excellent anti-corrosive effects with acceptable drop ejection characteristics. With higher concentrations of PVA, drop ejection characteristics become unacceptable due to the onset of kogation; while at lower concentrations of PVA, it becomes less effective in reducing corrosion.

PVA has the additional advantage of being relatively benign, having little or no interaction with other ink components, and does not therefore affect the overall balance of ink properties at the required concentrations.

While all PVAs tested appeared to have similar effectiveness against corrosion, generally the more soluble PVAs were preferred from the standpoint of formulating inks. Accordingly, PVAs with a relatively low molecular weight (e.g. 5000 to 15,000 g/mol) and with a relatively low degree of hydrolysis (e.g. 70% to 90%) were generally preferred.

While PVAs have been used in the field of inkjet technology previously, they have typically been used in promoting adhesion of inks to media, either as a primer fluid (see, for example, U.S. Pat. No. 10,414,189) or as part of an ink-receptive layer on media (see, for example, US 2011/0279554). For such purposes, high-viscosity, high molecular weight PVAs are used at high concentrations. Hitherto, the use of PVA at very low concentrations in inks for increasing printhead lifetimes has not been described in the literature.

Colorants, ink vehicles and printheads suitable for use in connection with the present disclosure are described in further detail below.

### Colorants

The inks utilized in the present disclosure may be of any type, but are typically dye-based inks which are known to be corrosive towards thermal inkjet heater elements.

Inkjet dyes will be well-known to the person skilled in the art and the present disclosure is not limited to any particular type of dye. By way of example, dyes suitable for use in the present disclosure include azo dyes, such as Food Black 2 and K1600 (as described in U.S. Pat. No. 8,834,620, the contents of which are incorporated herein by reference), metal complex dyes, naphthol dyes, anthraquinone dyes, indigo dyes, carbonium dyes, quinone-imine dyes, xanthene dyes, cyanine dyes, quinoline dyes, nitro dyes, nitroso dyes, benzoquinone dyes, naphthoquinone dyes, phthalocyanine dyes (including naphthalocyanine dyes), and metal phthalocyanine dyes (including metal naphthalocyanine dyes, such as those described in U.S. Pat. No. 7,148,345).

Specific examples of suitable dyes include: CI Direct Black 4, 9, 11, 17, 19, 22, 32, 80, 151, 154, 168, 171, 194 and 195; CI Direct Blue 1, 2, 6, 8, 22, 34, 70, 71, 76, 78, 86, 142, 199, 200, 201, 202, 203, 207, 218, 236 and 287; CI Direct Red 1, 2, 4, 8, 9, 11, 13, 15, 20, 28, 31, 33, 37, 39, 51, 59, 62, 63, 73, 75, 80, 81, 83, 87, 90, 94, 95, 99, 101, 110, 189, 225 and 227; CI Direct Yellow 1, 2, 4, 8, 11, 12, 26, 27, 28, 33, 34, 41, 44, 48, 86, 87, 88, 132, 135, 142 and 144; CI Food Black 1 and 2; CI Acid Black 1, 2, 7, 16, 24, 26, 28, 31, 48, 52, 63, 107, 112, 118, 119, 121, 172, 194 and 208; CI Acid Blue 1, 7, 9, 15, 22, 23, 27, 29, 40, 43, 55, 59, 62, 78, 80, 81, 90, 102, 104, 111, 185 and 254; CI Acid Yellow 1, 3, 4, 7, 11, 12, 13, 14, 19, 23, 25, 34, 38, 41, 42, 44, 53, 55, 61, 71, 76 and 79; CI Reactive Blue 1, 2, 3, 4, 5, 6, 7, 8, 9, 13, 14, 15, 17, 18, 19, 20, 21, 25, 26, 27, 28, 29, 31, 32, 33, 34, 37, 38, 39, 40, 41, 43, 44 and 46; CI Reactive Red 1, 2, 3, 4, 5, 6, 7, 8, 11, 12, 13, 15, 16, 17, 19, 20, 21, 22, 23, 24, 28, 29, 31, 32, 33, 34, 35, 36, 37, 38, 39, 40, 41, 42, 43, 44, 45, 46, 49, 50, 58, 59, 63, 64, and 180; CI Reactive Yellow 1, 2, 3, 4, 6 7, 11, 12, 13, 14, 15, 16, 17, 18, 22, 23, 24, 25, 26, 27, 37 and 42; CI Reactive Black 1, 3, 4, 5, 6, 8, 9, 10, 12, 13, 14 and 18; Pro-Jet® Fast Cyan 2 (Fujifilm Imaging Colorants); Pro-Jet® Fast Magenta 2 (Fujifilm Imaging Colorants); Pro-Jet® Fast Yellow 2 (Fujifilm Imaging Colorants); and Pro-Jet® Fast Black 2 (Fujifilm Imaging Colorants)

Colorants, such as dyes, may be used in inkjet inks either individually or as a combination of two or more thereof. For example, the ink may contain a primary dye and one or more tinting dyes to provide optimal gamut.

### Ink Vehicle

Ink vehicles for inkjet inks will be well known to the person skilled in the art and the ink vehicles used in the present disclosure are not particularly limited. The ink vehicles used in the present disclosure are typically conventional aqueous ink vehicles comprising at least 40 wt % water, at least 50 wt % water or at least 60 wt % water. Usually, the amount of water present in the inkjet ink is in the range of 50 wt % to 90 wt %, or optionally in the range of 60 wt % to 80 wt %.

Aqueous inkjet inks compositions are well known in the literature and, in addition to water, may comprise other components, such as co-solvents (including humectants, penetrants, wetting agents etc.), surfactants, biocides, sequestering agents, pH adjusters, viscosity modifiers, etc.

Co-solvents are typically water-soluble organic solvents. Suitable water-soluble organic solvents include C₁₋₄ alkyl alcohols, such as ethanol, methanol, butanol, propanol, 1-propanol and 2-propanol; glycol ethers, such as ethylene glycol monomethyl ether, ethylene glycol monoethyl ether, ethylene glycol monobutyl ether, ethylene glycol monomethyl ether acetate, diethylene glycol monomethyl ether, diethylene glycol monoethyl ether, diethylene glycol mono-n-propyl ether, ethylene glycol mono-isopropyl ether, diethylene glycol mono-isopropyl ether, ethylene glycol mono-n-butyl ether, diethylene glycol mono-n-butyl ether, triethylene glycol mono-n-butyl ether, ethylene glycol mono-t-butyl ether, diethylene glycol mono-t-butyl ether, 1-methyl-1-methoxybutanol, propylene glycol monomethyl ether, propylene glycol monoethyl ether, propylene glycol mono-t-butyl ether, propylene glycol mono-n-propyl ether, propylene glycol mono-isopropyl ether, dipropylene glycol monomethyl ether, dipropylene glycol monoethyl ether, dipropylene glycol mono-n-propyl ether, dipropylene glycol mono-isopropyl ether, propylene glycol mono-n-butyl ether, and dipropylene glycol mono-n-butyl ether; formamide, acetamide, dimethyl sulfoxide, sorbitol, sorbitan, glycerol monoacetate, glycerol diacetate, glycerol triacetate, and sulfolane; or combinations thereof.

Other useful water-soluble organic solvents, which may be used as co-solvents, include polar solvents, such as 2-pyrrolidone, N-methylpyrrolidone, ε-caprolactam, dimethyl sulfoxide, sulfolane, morpholine, N-ethylmorpholine, 1,3-dimethyl-2-imidazolidinone and combinations thereof.

The inkjet ink may contain a high-boiling water-soluble organic solvent as a co-solvent, which can serve as a wetting agent or humectant for imparting water retentivity and wetting properties to the ink composition. Such a high-boiling water-soluble organic solvent includes one having a boiling point of 180° C. or higher. Examples of the water-soluble organic solvent having a boiling point of 180° C. or higher are ethylene glycol, propylene glycol, diethylene glycol, pentamethylene glycol, trimethylene glycol, 2-butene-1,4-diol, 2-ethyl-1,3-hexanediol, 2-methyl-2,4-pentanediol, tripropylene glycol monomethyl ether, dipropylene glycol monoethyl glycol, dipropylene glycol monoethyl ether, dipropylene glycol monomethyl ether, dipropylene glycol, triethylene glycol monomethyl ether, tetraethylene glycol, triethylene glycol, diethylene glycol monobutyl ether, diethylene glycol monoethyl ether, diethylene glycol monomethyl ether, tripropylene glycol, polyethylene glycols having molecular weights of 2000 or lower, 1,3-propylene glycol, isopropylene glycol, isobutylene glycol, 1,4-butanediol, 1,3-butanediol, 1,5-pentanediol, 1,6-hexanediol, glycerol, trimethylolpropane, erythritol, pentaerythritol and combinations thereof.

Other suitable wetting agents or humectants include saccharides (including monosaccharides, oligosaccharides and polysaccharides) and derivatives thereof (e.g. maltitol, sorbitol, xylitol, hyaluronic salts, aldonic acids, uronic acids etc.)

The inkjet ink may also contain a penetrant, as one of the co-solvents, for accelerating penetration of the aqueous ink into the recording medium. Suitable penetrants include polyhydric alcohol alkyl ethers (glycol ethers) and/or 1,2-alkyldiols. Examples of suitable polyhydric alcohol alkyl ethers are ethylene glycol monomethyl ether, ethylene glycol monoethyl ether, ethylene glycol monobutyl ether, ethylene glycol monomethyl ether acetate, diethylene glycol monomethyl ether, diethylene glycol monoethyl ether, ethylene glycol mono-n-propyl ether, ethylene glycol mono-isopropyl ether, diethylene glycol mono-isopropyl ether, ethylene glycol mono-n-butyl ether, diethylene glycol mono-n-butyl ether, triethylene glycol mono-n-butyl ether, ethylene glycol mono-t-butyl ether, diethylene glycol mono-t-butyl ether, 1-methyl-1-methoxybutanol, propylene glycol monomethyl ether, propylene glycol monoethyl ether, propylene glycol mono-t-butyl ether, propylene glycol mono-n-propyl ether, propylene glycol mono-isopropyl ether, dipropylene glycol monomethyl ether, dipropylene glycol monoethyl ether, dipropylene glycol mono-n-propyl ether, dipropylene glycol mono-isopropyl ether, propylene glycol mono-n-butyl ether, and dipropylene glycol mono-n-butyl ether. Examples of suitable 1,2-alkyldiols are 1,2-pentanediol and 1,2-hexanediol. The penetrant may also be selected from straight-chain hydrocarbon diols, such as 1,3-propanediol, 1,4-butanediol, 1,5-pentanediol, 1,6-hexanediol, 1,7-heptanediol, and 1,8-octanediol. Glycerol may also be used as a penetrant.

Typically, the amount of co-solvent present in the ink is in the range of about 5 wt % to 50 wt %, or optionally 10 wt % to 40 wt %.

The inkjet ink may also contain one or more surface active agents (“surfactant”), such as an anionic surface active agent, a zwitterionic surface active agent, a nonionic surface active agent or mixtures thereof. Useful anionic surface active agents include sulfonic acid types, such as alkanesulfonic acid salts, α-olefinsulfonic acid salts, alkylbenzenesulfonic acid salts, alkylnaphthalenesulfonic acids, acylmethyltaurines, and dialkylsulfosuccinic acids; alkylsulfuric ester salts, sulfated oils, sulfated olefins, polyoxyethylene alkyl ether sulfuric ester salts; carboxylic acid types, e.g., fatty acid salts and alkylsarcosine salts; and phosphoric acid ester types, such as alkylphosphoric ester salts, polyoxyethylene alkyl ether phosphoric ester salts, and glycerophosphoric ester salts. Specific examples of the anionic surface active agents are sodium dodecylbenzenesulfonate, sodium laurate, and a polyoxyethylene alkyl ether sulfate ammonium salt.

Examples of zwitterionic surface active agents include N,N-dimethyl-N-octyl amine oxide, N,N-dimethyl-N-dodecyl amine oxide, N,N-dimethyl-N-tetradecyl amine oxide, N,N-dimethyl-N-hexadecyl amine oxide, N,N-dimethyl-N-octadecyl amine oxide and N,N-dimethyl-N-(Z-9-octadecenyl)-N-amine oxide.

Examples of nonionic surface active agents include ethylene oxide adduct types, such as polyoxyethylene alkyl ethers, polyoxyethylene alkylphenyl ethers, polyoxyethylene alkyl esters, and polyoxyethylene alkylamides; polyol ester types, such as glycerol alkyl esters, sorbitan alkyl esters, and sugar alkyl esters; polyether types, such as polyhydric alcohol alkyl ethers; and alkanolamide types, such as alkanolamine fatty acid amides. Specific examples of nonionic surface active agents are ethers such as polyoxyethylene nonylphenyl ether, polyoxyethylene octylphenyl ether, polyoxyethylene dodecylphenyl ether, polyoxyethylene alkylallyl ether, polyoxyethylene oleyl ether, polyoxyethylene lauryl ether, and polyoxyalkylene alkyl ethers (e.g. polyoxyethylene alkyl ethers); and esters, such as polyoxyethylene oleate, polyoxyethylene oleate ester, polyoxyethylene distearate, sorbitan laurate, sorbitan monostearate, sorbitan mono-oleate, sorbitan sesquioleate, polyoxyethylene mono-oleate, and polyoxyethylene stearate.

Acetylene glycol surface active agents, such as 2,4,7,9-tetramethyl-5-decyne-4,7-diol; ethoxylated 2,4,7,9-tetramethyl-5-decyne-4,7-diol; 3,6-dimethyl-4-octyne-3,6-diol or 3,5-dimethyl-1-hexyn-3-ol, may also be used. Specific examples of nonionic surfactants, which may be used in the present disclosure, are Surfynol® 465 and Surfynol® 440 (available from Air Products and Chemicals, Inc)

The surfactant(s) are typically present in the aqueous inkjet ink in an amount ranging from 0.05 wt % to 2 wt %.

The aqueous inkjet ink may also include a pH adjuster or buffer, such as sodium hydroxide, potassium hydroxide, lithium hydroxide, sodium carbonate, sodium hydrogencarbonate, potassium carbonate, potassium hydrogencarbonate, lithium carbonate, sodium phosphate, potassium phosphate, lithium phosphate, potassium dihydrogenphosphate, dipotassium hydrogenphosphate, sodium oxalate, potassium oxalate, lithium oxalate, sodium borate, sodium tetraborate, potassium hydrogenphthalate, and potassium hydrogentartrate; ammonia; and amines, such as methylamine, ethylamine, diethylamine, trimethylamine, triethylamine, tris(hydroxymethyl)aminomethane hydrochloride, triethanolamine, diethanolamine, diethylethanolamine, triisopropanolamine, butyldiethanolamine, morpholine, propanolamine, 4-morpholineethanesulfonic acid and 4-morpholinepropanesulfonic acid (“MOPS”). The amount of pH adjuster, when present, is typically in the range of from 0.01 to 2 wt. % or 0.05 to 1 wt. %.

The aqueous inkjet ink may also include a biocide, such as benzoic acid, dichlorophene, hexachlorophene, sorbic acid, hydroxybenzoic esters, sodium dehydroacetate, 1,2-benthiazolin-3-one (“Proxel® GXL”, available from Arch Chemicals, Inc.), 3,4-isothiazolin-3-one or 4,4-dimethyloxazolidine. The amount of biocide, when present, is typically in the range of from 0.01 to 2 wt. % or 0.05 to 1 wt. %.

The aqueous inkjet ink may also contain a sequestering agent, such as ethylenediaminetetraacetic acid (EDTA).

### Inkjet Printheads

The inks according to the present disclosure are primarily for use in connection with thermal inkjet printheads, although they may be used in other types of printhead, especially those where an actuator contacts the ink. For the sake of completeness, there now follows a brief description of one of the Applicant's thermal inkjet printheads, as described in U.S. Pat. No. 7,303,930, the contents of which is herein incorporated by reference.

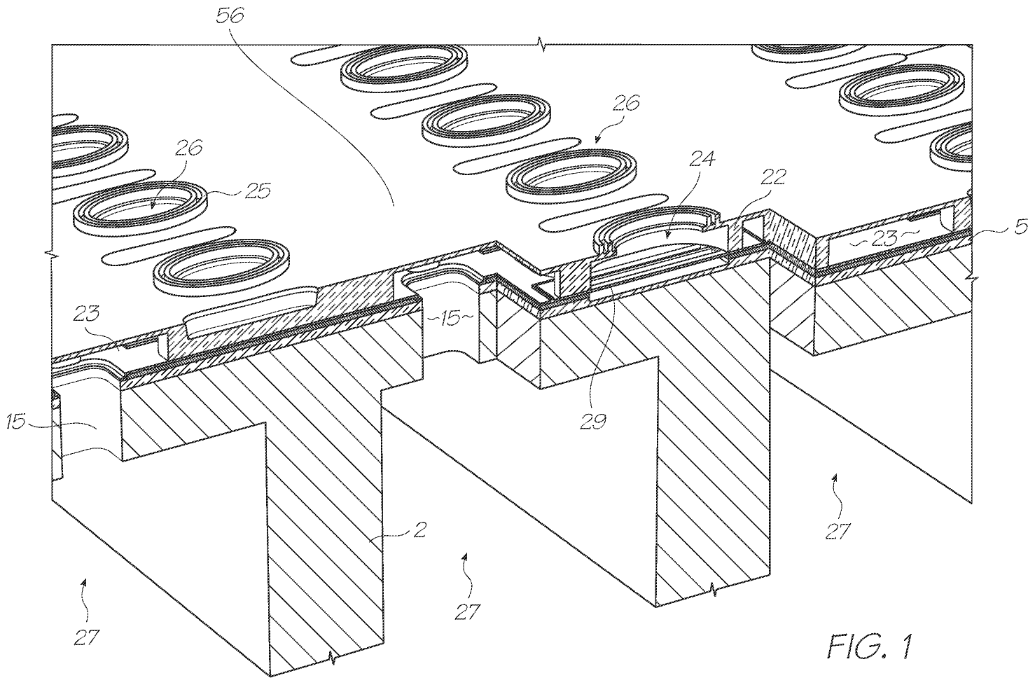

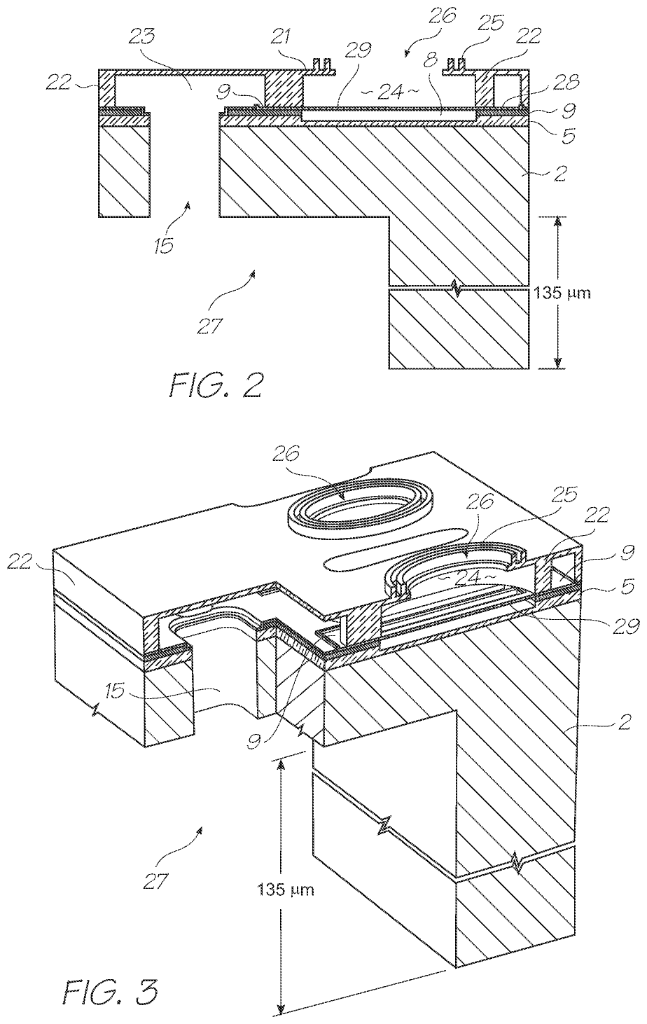

Referring to FIG. 1, there is shown part of printhead comprising a plurality of nozzle assemblies. FIGS. 2 and 3 show one of these nozzle assemblies in side-section and cutaway perspective views.

Each nozzle assembly comprises a nozzle chamber 24 formed by MEMS fabrication techniques on a silicon wafer substrate 2. The nozzle chamber 24 is defined by a roof 21 and sidewalls 22 which extend from the roof 21 to the silicon substrate 2. As shown in FIG. 1, each roof is defined by part of a nozzle plate 56, which spans across an ejection face of the printhead. The nozzle plate 56 and sidewalls 22 are formed of the same material, which is deposited by PECVD over a sacrificial scaffold of photoresist during MEMS fabrication. Typically, the nozzle plate 56 and sidewalls 21 are formed of a ceramic material, such as silicon dioxide or silicon nitride. These hard materials have excellent properties for printhead robustness, and their inherently hydrophilic nature is advantageous for supplying ink to the nozzle chambers 24 by capillary action.

Returning to the details of the nozzle chamber 24, it will be seen that a nozzle opening 26 is defined in a roof of each nozzle chamber 24. Each nozzle opening 26 is generally elliptical and has an associated nozzle rim 25. The nozzle rim 25 assists with drop directionality during printing as well as reducing, at least to some extent, ink flooding from the nozzle opening 26. The actuator for ejecting ink from the nozzle chamber 24 is a heater element 29 positioned beneath the nozzle opening 26 and suspended across a pit 8. Current is supplied to the heater element 29 via electrodes 9 connected to drive circuitry in underlying CMOS layers of the substrate 2. When a current is passed through the heater element 29, it rapidly superheats surrounding ink to form a gas bubble, which forces ink through the nozzle opening 26. By suspending the heater element 29, it is completely immersed in ink when the nozzle chamber 24 is primed. This improves printhead efficiency, because less heat dissipates into the underlying substrate 2 and more input energy is used to generate a bubble. Typically, the heater element is comprised of a metal or a conductive ceramic material. Examples of suitable materials include titanium nitride, titanium aluminium nitride and titanium-aluminium alloy.

As seen most clearly in FIG. 1, the nozzles are arranged in rows and an ink supply channel 27 extending longitudinally along the row supplies ink to each nozzle in the row. The ink supply channel 27 delivers ink to an ink inlet passage 15 for each nozzle, which supplies ink from the side of the nozzle opening 26 via an ink conduit 23 in the nozzle chamber 24.

A MEMS fabrication process for manufacturing such printheads is described in detail in U.S. Pat. No. 7,303,930, the contents of which are herein incorporated by reference.

The operation of printheads having suspended heater elements is described in detail in the Applicant's U.S. Pat. No. 7,278,717, the contents of which are incorporated herein by reference.

The Applicant has also described thermal bubble-forming inkjet printheads having bonded heater elements. Such printheads are described in, for example, U.S. Pat. No. 7,246,876 and US 2006/0250453, the contents of which are herein incorporated by reference.

The inkjet inks of the present disclosure function optimally in combination with the Applicant's thermal inkjet printheads, as described above. However, their use is not limited to the Applicant's thermal printheads. The inks described herein may be used in other types of thermal bubble-forming inkjet printheads, piezoelectric printheads, thermal-bend actuated printheads (as described in, for example, U.S. Pat. Nos. 7,926,915; 7,669,967; and 8,998,383, the contents of which are incorporated herein by reference) etc.

For the sake of completeness, inkjet printers incorporating the Applicant's thermal inkjet printheads are described in, for example, U.S. Pat. Nos. 7,201,468; 7,360,861; 7,380,910; and 7,357,496, the contents of each of which are herein incorporated by reference.

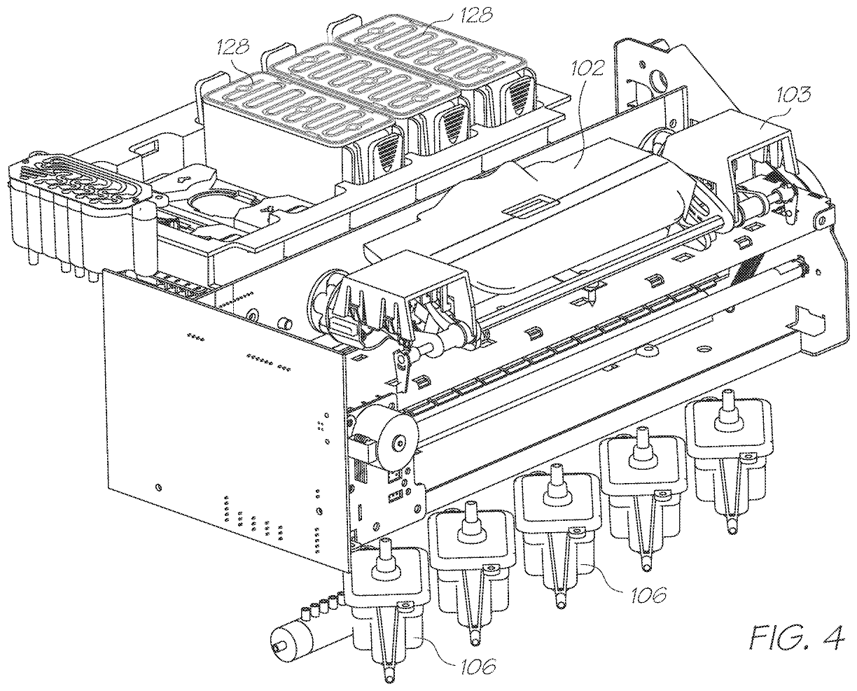

FIG. 4 shows a print engine 103 for a thermal inkjet printer, as described in Applicant's U.S. Pat. No. 8,066,359, the contents of which is herein incorporated by reference. The print engine 103 includes a removable print cartridge 102, comprising a pagewidth printhead, and a bank of user-replaceable ink cartridges 128. Each color channel typically has its own ink reservoir 128 and a corresponding pressure-regulating chamber 106 for regulation of a hydrostatic pressure of ink supplied to the printhead. Hence, the print engine 103 has five ink reservoirs 128 and five corresponding pressure-regulating chambers 106. Typically, the ink channels (“color channels”) employed in this five-channel print engine 103 are CMYK₁K₂. The ink channel order may be arranged so as to optimize preferred ink color mixing effects at the nozzle plate of the printhead, as described in US2013/0070024, the contents of which are herein incorporated by reference. For example, an ink channel order of CK₁MK₂Y may be employed where cyan (C) is positioned furthest upstream and yellow (Y) is positioned furthest downstream.

Each ink cartridge 128 may comprise an ink composition as described herein. Although fluidic connections between the various components are not shown in FIG. 4, it will be appreciated that these connections are made with suitable hoses in accordance with the fluidics system described in, for example, U.S. Pat. No. 8,066,359, the contents of which are incorporated herein by reference.

### Experimental Section

Accelerated printhead lifetime tests were conducted on various inks in accordance with the method described below.

Printhead integrated circuits (PHICs) having uncoated titanium aluminium nitride resistive heater elements were mounted individually for operation in a modified printing rig. Actuation pulse widths were controlled to replicate operation in an otherwise unmodified printer. Resistance rise of the heaters (expressed as a percentage rise from the start of the experiment) was recorded after 50 million actuations. The resistance rise correlates to the rate of corrosion of heater elements in the PHIC.

A baseline ink formulation containing no additive, as shown in Table 1, was prepared and filtered (0.2 microns) prior to use.

TABLE 1
Baseline ink formulation for accelerated printhead lifetime tests

| Ink Component | Amount (wt. %) |
|---|---|
| Ethylene glycol | 9.00 |
| Triethylene glycol | 10.0 |
| Glycerol | 2.00 |
| K1600¹ | 3.90 |
| Surfynol ® 465² | 0.30 |
| Proxel ® GXL³ | 0.20 |
| water | balance |

¹K1600 is a black disazo dye, as described in U.S. Pat. No. 8,834,620
²Surfynol ® 465 is ethoxylated 2,4,7,9-tetramethyl-5-decyne-4,7-diol
³Proxel ® GXL is 1,2-benzisothiazolin-3-one

Inks 1-9 were prepared using the baseline ink formulation with various additives in the amounts shown in Table 2. Each ink was tested in the modified printing rig described above and the resistance rise for each ink measured after 50 million ejections (normalized against the baseline ink containing no additive). For some ink candidates, qualitative kogation observations were reported as a score from 1 to 5 (1=baseline kogation; 5=heavy kogation/misdirected droplets). The results from these accelerated printhead lifetime tests are shown in Table 2.

TABLE 2
Accelerated printhead lifetime tests for various additives

| | | Normalized | |
|---|---|---|---|
| | | resistance | Kogation |
| Ink Number | Additive | rise @ 50M | score |
| Baseline | None | 100% | 1 |
| Ink 1 | Butoxyne ™ (2 wt. %) | 85% | N/A |
| Ink 2 | Betaine (0.1 wt. %) | 121% | N/A |
| Ink 3 | Ascorbic acid (0.1 wt %) | 114% | N/A |
| Ink 4 | Boric acid (350 ppm) | 123% | N/A |
| Ink 5 | Glycine (0.2 wt. %) | 97% | N/A |
| Ink 6 | Al(NO₃)₃ (50 ppm) | 101% | N/A |
| Ink 7 | 1,2-Hexanediol (2 wt. %) | 101% | N/A |
| Ink 8 | Dowsil ™ 8526 (0.3 wt. %) | N/A | 5 |
| | | (50M not reached) | |
| Ink 9 | Dowsil ™ 8526 (0.1 wt. %) | 42% | 5 |

From Table 2, it can be seen that, with the exception of the known anti-corrosion additive Butoxyne™, most additives tested had either negligible effect or an undesirable accelerating effect on the rate of corrosion compared to the baseline formulation containing no additive.

Interestingly, Dow Corning Dowsil™ 8526 (an ethoxylated silicone polymer having a molecular weight in the range of 6000 to 8000 g/mol) showed promising anti-corrosion performance at relatively low concentration. Presumably, the silicone polymer was forming a protective layer on the heater element, which minimizes corrosive attack by the dye species. However, kogation was observed to be very poor, both via drop ejection characteristics and visual inspection of heater elements. Therefore, this silicone polymer additive was clearly unacceptable for use in ink formulations, either at 0.3 wt % or 0.1 wt %.

Nevertheless, Dow Corning Dowsil™ 8526 was identified as a candidate for further testing based on its promising anti-corrosion performance. It was hypothesized that kogation could be ameliorated either at lower concentrations or with the addition of a known anti-kogation additive (Liponic®-EG 1). Table 3 shows the results of testing with Dow Corning Dowsil™ 8526 compared to the baseline formulation.

TABLE 3
Accelerated printhead lifetime tests for Dow Corning Dowsil ™ 8526

| | | Normalized | |
|---|---|---|---|
| Ink | | resistance rise | Kogation |
| Number | Additive(s) | @ 50M | score |
| Baseline | None | 100% | 1 |
| Ink 8 | Dowsil ™ 8526 (0.3 wt. %) | N/A | 5 |
| | | (50M not | |
| | | reached) | |
| Ink 9 | Dowsil ™ 8526 (0.1 wt. %) | 42% | 5 |
| Ink 10 | Dowsil ™ 8526 (0.01 wt. %) | 50% | 5 |
| Ink 11 | Dowsil ™ 8526 (0.01 wt. %) + | 62% | 5 |
| | LEG-1 (2 wt. %) | | |
| Ink 12 | Dowsil ™ 8526 (0.005 wt. %) | 59% | 4 |
| Ink 13 | Dowsil ™ 8526 (0.001 wt. %) | 92% | 1 |

Disappointingly, all inks tested containing the ethoxylated silicone (Dow Corning Dowsil™ 8526) had either unacceptable kogation or a negligible anti-corrosive effect. For example, Ink 12 had excellent anti-corrosive performance at a concentration of 0.005 wt. % (50 ppm) but still had very poor kogation performance. On the other hand, Ink 13 had acceptable kogation performance at a concentration of 0.001 wt. % (10 ppm), but negligible anti-corrosive effect. Therefore, with the Dowsil™ 8526 additive, there was no formulation space where anti-corrosive effects were useful without unacceptable kogation.

With the rationale that a low concentration of a water-soluble polymer could provide an anti-corrosive effect via a protective coating on the heater element, polyvinyl alcohol was identified as an alternative candidate to the ethoxylated silicone. The results for various polyvinyl alcohol (PVA) additives and one polyvinyl pyrollidone (PVP) additive are shown in Table 4.

TABLE 4
Accelerated printhead lifetime tests for PVA and PVP additives

| | | Normalized | |
|---|---|---|---|
| Ink | | resistance rise | Kogation |
| Number | Additive | @ 50M | score |
| Baseline | None | 100% | 1 |
| Ink 14 | PVA [MW 9000; 80% hydrolysed] | 42% | 1 |
| | (100 ppm) | | |
| Ink 15 | PVA [MW 13000; 88% hydrolysed] | 50% | 1 |
| | (100 ppm) | | |
| Ink 16 | PVA [MW 13000; 99% hydrolysed] | 62% | 1 |
| | (100 ppm) | | |
| Ink 17 | PVP-10 [MW 10000] (100 ppm) | 85% | 3 |

Although PVA has a similar solubility to Dow Corning Dowsil™ 8526 and a similar molecular weight, PVA showed remarkably improved kogation results compared to the ethoxylated silicone additive whilst maintaining excellent anti-corrosive performance. Comparison with a similar water-soluble polymer (PVP-10) demonstrated that corrosion and kogation performance could not be predicted simply on the basis of solubility and/or molecular weight alone-Ink 17 had poorer corrosion and kogation performance than Inks 14-16. Serendipitously, it appeared that PVA was interacting with the heater element during droplet ejection in a way that other polymers were not, such that inks containing PVA were less prone to kogation than inks containing other polymer additives. Of course, it was not possible to investigate individual polymer interactions with the heater element under the high temperature and high pressure environment in inkjet nozzle chambers during droplet ejection.

Comparing Inks 14-16, it was observed that a lower molecular weight PVA was preferred, both from the point of view of formulating the ink as well as corrosive/kogative performance. Similarly, a lower degree of hydrolysis was preferred, pointing to a general preference for more soluble PVAs for optimizing ink formulations with improved printhead lifetimes.

Compared with other polymer additives, PVA additives can switch the failure mode of inks from a kogative failure mode (typical of most polymers) to a corrosive failure mode, thereby extending overall lifetimes. However, kogation is not entirely eliminated with PVA additives and it is therefore desirable to minimize, to the extent possible, the amount of PVA in any ink formulation. A minimal amount of PVA in the ink formulation achieves a desirable balance between corrosion and kogation so as to optimize both printhead lifetime and print quality.

Table 5 shows the effect of increasing the amount of PVA on corrosive and kogative performance for a reference ink formulation. The PVA added in each of Inks 18 to 23 had a molecular weight of 9000 g/mol and a degree of hydrolysis of 80%. In this series of experiments, actual lifetimes before failure are reported.

TABLE 5
Actual printhead lifetime tests for PVA additive

| Ink Number | Additive | Lifetime | Failure Mode |
|---|---|---|---|
| Reference | None | 120M | corrosive |
| Ink 18 | PVA (10 ppm) | 240M | corrosive |
| Ink 19 | PVA (50 ppm) | 260M | corrosive |
| Ink 20 | PVA (100 ppm) | 300M | corrosive |
| Ink 21 | PVA (200 ppm) | 260M | corrosive |
| Ink 22 | PVA (500 ppm) | 50M | kogative |
| Ink 23 | PVA (1000 ppm) | 50M | kogative |

The anti-corrosive effects of PVA were observable at a concentration as low as 10 ppm compared to the reference ink formulation. However, it was anticipated that the anticorrosive effects of PVA would diminish significantly at concentrations lower than about 5 ppm.

While PVA concentrations of up to 200 ppm could be tolerated, kogation performance generally deteriorated, as expected, with increasing concentrations of PVA. At PVA concentrations of 500 ppm and 1000 ppm, the kogative failure mode dominated and lifetimes dramatically decreased as a result of kogation. Without wishing to be bound by theory, it is understood by the present inventors that a threshold amount of PVA is required to coat the surface of the heater element in order to minimize corrosion. However, once the amount of PVA reaches a requisite ‘saturation’ on the surface of the heater element, then increasing amounts of PVA have little effect on the corrosion rate but, rather, decrease lifetimes via the kogative failure mechanism.

Of course, the optimal amount of PVA for any ink formulation will depend on the aggressiveness of the corrosive component (e.g. dye) as well as other formulation components. It will be appreciated by the person skilled in the art that an optimal PVA concentration within the range of 5 to 250 ppm can be determined empirically for a given ink formulation depending on the balanced requirements between print quality and printhead lifetime.

It will, of course, be appreciated that the present disclosure has been described by way of example only and that modifications of detail may be made within the scope of the disclosure, which is defined in the accompanying claims.

1. An inkjet ink comprising:
an aqueous-based ink vehicle; and
5 to 250 ppm of a polyvinyl alcohol.

2. The inkjet ink of claim 1, wherein the polyvinyl alcohol is present in an amount ranging from 10 to 200 ppm.

3. The inkjet ink of claim 1, wherein the polyvinyl alcohol has a molecular weight in the range of 5000 to 15,000 g/mol.

4. The inkjet ink of claim 1, wherein the polyvinyl alcohol has a degree of hydrolysis in the range of 70 to 90%.

5. The inkjet ink of claim 1, further comprising a corrosive component.

6. The inkjet of claim 5, wherein the corrosive component comprises a dye.

7. The inkjet ink of claim 1, wherein the ink vehicle comprises 5 to 50 wt. % of one or more co-solvents.

8. The inkjet ink of claim 1, wherein the ink vehicle comprises 0.05 to 2 wt % of at least one surfactant.

9. The inkjet ink of claim 1, wherein the ink is absent any polymers having a molecular weight greater than 5000 g/mol, other than the polyvinyl alcohol.

10. The inkjet ink of claim 1, which is absent any polymers having a molecular weight greater than 3000 g/mol, other than the polyvinyl alcohol.

11. A method of improving a lifetime of an inkjet printhead, the method comprising the steps of:
supplying an ink according to claim 1 to nozzle chambers of the printhead, each nozzle chamber having an associated actuator in contact with the ink; and
actuating one or more of the actuators to eject ink from the printhead.

12. The method of claim 11, wherein each actuator comprises a resistive heater element.

13. The method of claim 12, wherein the heater element is an uncoated and comprises a material selected from the group consisting of:
a titanium alloy;
titanium nitride; and
a nitride of a titanium alloy.

14. The method of claim 11, wherein the lifetime is improved compared to a corresponding ink in which the polyvinyl alcohol is absent.
